(19) United States
(12) Patent Application Publication
(10) Pub. No.: US 2009/0128032 A1
(43) Pub. Date: May 21, 2009

(54) Plasma display panel and green phosphor for the same

(76) Inventor: Young-Kwan Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/289,965

(22) Filed: Nov. 7, 2008

(30) Foreign Application Priority Data
Nov. 16, 2007 (KR) 10-2007-0117517

(51) Int. Cl. H01J 17/49; C09K 11/59; C09K 11/54

(52) U.S. Cl. 313/582; 252/301.4 R; 252/301.6 R

(57) ABSTRACT

A green phosphor for a PDP includes a BAM based green phosphor, and a passivation layer on the BAM based green phosphor, the passivation layer including a metal oxide. The green phosphor increasing lifespan and discharge stability of the PDP.

### BACKGROUND OF THE INVENTION

1. Field of the Invention

Example embodiments relate to a plasma display panel (PDP). More particularly, example embodiments relate to a PDP having green phosphor exhibiting long lifespan and high discharge stability.

2. Description of the Related Art

A PDP refers to a display apparatus, e.g., a flat display panel (FDP) apparatus, using a plasma phenomenon. When a predetermined potential difference is applied between two spatially separated contact points at a non-vacuous gas atmosphere, a gas discharge phenomenon may be generated to display an image. In particular, the image may be displayed by visible light emitted from phosphors excited by the gas discharge in the PDP.

A conventional PDP may include red, green, and blue phosphors for emitting red, green, and blue visible lights, respectively. For example, conventional green phosphor may include Zn₂SiO₄:Mn. The Zn₂SiO₄:Mn, however, may have poor discharge characteristic. In particular, a surface charge characteristic of the Zn₂SiO₄:Mn may be negative, so a probability of defective gas discharge in the PDP may increase, e.g., unstable discharge, a failure to discharge, and so forth, thereby deteriorating the phosphor and decreasing display properties of the PDP.

### SUMMARY OF THE INVENTION

Example embodiments are therefore directed to a green phosphor and to a PDP including the same, which substantially overcome one or more of the disadvantages of the related art.

It is therefore a feature of an embodiment to provide a green phosphor exhibiting a positive surface charge while maintaining high color purity.

It is another feature of an embodiment to provide a green phosphor exhibiting long lifespan and high discharge stability.

It is yet another feature of an embodiment to provide a PDP having a green phosphor with one or more of the above features.

At least one of the above and other features and advantages may be realized by providing a green phosphor for a PDP, including a BAM based green phosphor, and a passivation layer on the BAM based green phosphor, the passivation layer including a metal oxide. The BAM based green phosphor may include BaMgAlₓO_{y}: Mn and/or (Ba,Sr,Mg)OαAl₂O₃:Mn, x being an integer in a range of about 10≦x≦20, y being an integer in a range of about 15≦y≦30, and α being an integer in a range of about 1≦α≦23. The metal oxide may have a positive surface charge. The metal oxide may include one or more of MgO, Al₂O₃, Y₂O₃, and ZnO. An amount of the metal oxide in the green phosphor may be about 0.5 wt % to about 5.5 wt % based on a total weight of the green phosphor. The passivation layer may be on an outer surface of the BAM based green phosphor.

At least one of the above and other features and advantages may be realized by providing a PDP, including a first substrate and a second substrate separated from each other by a predetermined distance to face each other, barrier ribs between the two substrates to define discharge cells, and phosphor layers in the discharge cells, the phosphor layers including at least one green phosphor layer, the green phosphor layer including a BAM based green phosphor, and a passivation layer on the BAM based green phosphor, the passivation layer including a metal oxide. The BAM based green phosphor may include BaMgAlₓO_{y}:Mn and/or (Ba,Sr,Mg)O αAl₂O₃:Mn, x being an integer in a range of about 10≦x≦20, y being an integer in a range of about 15≦y≦30, and α being an integer in a range of about 1≦α≦23. The metal oxide may have a positive surface charge. The metal oxide may include one or more of MgO, Al₂O₃, Y₂O₃, and ZnO. An amount of the metal oxide in the green phosphor may be about 0.5 wt % to about 5.5 wt % based on a total weight of the green phosphor.

### BRIEF DESCRIPTION OF THE DRAWINGS

The above and other features and advantages will become more apparent to those of ordinary skill in the art by describing in detail exemplary embodiments with reference to the attached drawing, in which:

FIG. 1 illustrates a perspective view of a PDP according to an example embodiment.

### DETAILED DESCRIPTION OF THE INVENTION

Korean Patent Application No. 10-2007-0117517, filed on Nov. 16, 2007, in the Korean Intellectual Property Office, and entitled: “Plasma Display Panel and Green Phosphor for the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not. As used herein, the terms “a” and “an” are open terms that may be used in conjunction with singular items or with plural items.

In order to have a PDP generating a substantially uniform and stable discharge, high temperature gas anions may be required to collide with positively charged phosphor surfaces, i.e., phosphors with high surface potential, at a high speed. Therefore, according to an example embodiment, a surface potential of the phosphors may be adjusted to exhibit a positive surface charge value in order to increase a potential difference between the phosphor surface and the anions, thereby realizing a plasma discharge having a uniform and stable emission characteristic. In particular, the surface potential of the phosphors may be adjusted by controlling a composition of the green phosphor to exhibit a positive surface charge.

According to an example embodiment, a green phosphor of a PDP may include a barium magnesium aluminate (BAM) phosphor coated with a metal oxide. The BAM phosphor in the green phosphor of an example embodiment may be formed to emit green light, and may have a high emission characteristic and high manufacturing process applicability. The metal oxide in the green phosphor may have a predetermined positive charge to offset a charge of the BAM phosphor, so a total surface charge of the BAM phosphor with the metal oxide, i.e., a surface charge of the BAM based green phosphor, may have a positive value. The BAM based green phosphor may be applied to the PDP as a film.

The BAM phosphor may be formed to emit green light, so a central metal ion of the BAM-based green phosphor may be adjusted accordingly, e.g., a Mn ion may be used in an example embodiment. It is noted that the central metal ion of the BAM-based green phosphor is different from a Eu central metal ion used in conventional blue light emitting BAM phosphor, e.g., conventional blue light emitting BAM phosphor may have relatively reduced brightness and lifespan.

Examples of the BAM phosphor according to an example embodiment may include one or more of BaAlₓO_{y}:Mn, BaMgAlₓO_{y}:Mn, and (Ba,Sr,Mg)OαAl₂O₃:Mn, were x, y, and α may be integers. For example, the values of x, y, and α may be 10≦x≦20, 15≦y≦30, and 1≦α≦23, respectively. For example, the BAM phosphor may include BaAl₁₂O₁₉:Mn. It is noted, e.g., that when 10≦x≦20 and 15≦y≦30 in BaMgAlₓO_{y}:Mn, stability of the crystalline structure and/or brightness of the BAM-based green phosphor may be improved.

The metal oxide in the green phosphor may have a positive surface charge characteristic. The positive surface charge characteristic may prevent the green phosphor from deteriorating, thereby increasing durability of the green phosphor and facilitating a manufacturing process thereof. Examples of the metal oxide may include one or more of MgO, Al₂O₃, Y₂O₃, and ZnO. An amount of the metal oxide in the green phosphor may be about 0.5 wt % to about 5.5 wt % with respect to a total weight of the green phosphor. The metal oxide may be coated on an outer surface of the BAM phosphor. The amount of the metal oxide on the BAM phosphor may be adjusted, so a zeta potential of the green phosphor may be optimized. Therefore, a proper, i.e., optimal, zeta potential of the green phosphor may be secured without deteriorating an emission characteristic of the green phosphor. For example, a metal oxide having a positive surface charge may be obtained by rubbing a reference material, e.g., solid Fe, against an object metal oxide.

The green phosphor may be formed according to any suitable method. For example, a green phosphor material, e.g., BAM, may be dispersed in a vehicle, i.e., a binder resin dissolved in a solvent, to form a phosphor paste.

Examples of the binder resin in the phosphor paste may include one or more of a cellulose based resin and an acryl based resin. Examples of the cellulose based resin may include a copolymer of acrylic monomers, e.g., methyl cellulose, ethyl cellulose, propyl cellulose, hydroxyl methyl cellulose, hydroxyl ethyl cellulose, hydroxyl propyl cellulose, hydroxyl ethyl propyl cellulose, or a mixture thereof. Examples of the acryl based resin may include poly methyl(meth)acrylate, poly isopropyl(meth)acrylate, poly isobutyl(meth)acrylate, a copolymer of acryl based monomers, e.g., one or more of methyl(meth)acrylate, ethyl(meth)acrylate, propyl(meth)acrylate, butyl(meth)acrylate, hexyl(meth)acrylate, 2-ethyl hexyl(meth)acrylate, benzyl(meth)acrylate, dimethyl amino ethyl(meth)acrylate, hydroxyl ethyl(meth)acrylate, hydroxyl propyl(meth)acrylate, hydroxyl butyl(meth)acrylate, phenoxy 2-hydroxy propyl(meth)acrylate, glicydil(meth)acrylate, or a mixture thereof. The binder resin may further include a small amount of an inorganic binder. An amount of the binder resin may be about 2 wt % to about 8 wt % with respect to a total weight of the phosphor paste.

Examples of the solvent in the phosphor paste may include an alcohol, e.g., terpineol, an ether, e.g., butyl cellosolve (BC), an ester, e.g., butyl carbitol acetate (BCA), or a mixture thereof. An amount of the solvent may be about 25 wt % to about 75 wt % with respect to the total weight of the phosphor paste. When the amount of the solvent is too high or too low, e.g., outside of the above range, fluid characteristics of the resultant phosphor paste may be improper for forming the green phosphor.

The phosphor paste may further include an additive to improve fluid and process characteristics thereof. Examples of the additive may include one or more of a photosensitizer, e.g., benzophenone, a dispersing agent, a silicon based antifoaming agent, a lubricating agent, a plasticizer, and an antioxidant.

Once the phosphor paste is formed, the phosphor paste may be applied to a predetermined surface, e.g., a surface of a discharge cell in a PDP, by any suitable method. For example, the phosphor paste may be applied by a screen printing method or spraying via a nozzle. The applied phosphor paste may be dried and baked, i.e., annealed, at a predetermined temperature, i.e., a sufficient temperature for decomposing and/or burning the binder resin, to form the phosphor layer.

The metal oxide may be deposited on a surface of the phosphor layer. For example, the metal oxide may form a metal oxide coating on an outer surface of the phosphor layer, i.e., a passivation layer on the surface of the phosphor layer. The metal oxide may be deposited by any suitable method, e.g., a plasma chemical vapor deposition (PVD) method, a chemical vapor deposition (CVD) method, a sputtering method, an electron beam evaporation method, a vacuum thermal evaporation method, a laser ablation method, a thermal evaporation method, a laser chemical vapor deposition method, a jet vapor deposition method, and so forth.

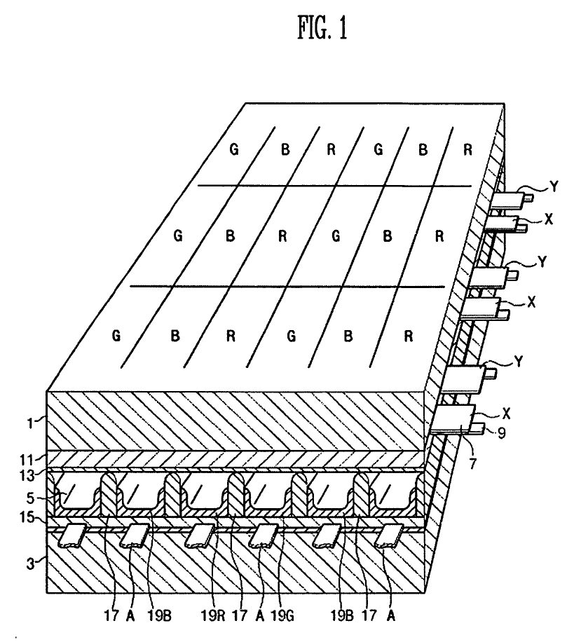

According to an example embodiment, the BAM-based green phosphor may be employed in discharge cells of a PDP. For example, as illustrated in FIG. 1, a PDP may include a top substrate 1 and a bottom substrate 3 facing each other with a discharge space interposed therebetween, a pair of sustain electrodes (scan electrodes X and common electrodes Y) separated from each other by a predetermined distance on the top substrate 1 in a predetermined pattern, a dielectric layer 11 for AC driving and an MgO passivation layer 13 on a surface of the dielectric layer 11, and address electrodes A, a dielectric layer 15, barrier ribs 17, and phosphor layers 19R, 19G, and 19B on the bottom substrate 3. The sustain electrodes may include transparent electrode films 7 and metal films 9.

The top substrate 1 and the bottom substrate 3 may face each other and overlap to form a sealed discharge space therebetween, i.e., a vacuous internal space. The barrier ribs 17 may be arranged to define discharge cells 5 in the discharge space. A discharge gas, e.g., helium (He), neon (Ne), xenon (Xe), or a gas mixture thereof, may be injected into the discharge space to fill the discharge cells 5. The sustain electrodes X and Y and the address electrodes A may be provided in the discharge space to intersect each other and correspond to the discharge cells 5. The red 19R, green 19G, and blue 19B phosphors may be arranged in a predetermined pattern in the discharge cells 5. When a predetermined voltage is applied between the electrodes, plasma discharge may be generated in the discharge cells 5 to trigger ultraviolet (UV) light, thereby exciting the red, green, and blue phosphor layers 19R, 19G, and 19B to emit red, green, and blue visible light, respectively.

In particular, before a discharge voltage is applied to the electrodes of the PDP, wall charges may be accumulated on the MgO layer 13 and on the red, green, and blue phosphor layers 19R, 19G, and 19B, i.e., surfaces that are directly exposed to the discharge space, during a reset discharge. Wall charges accumulated on the top and bottom substrate 1 and 3 may have opposite polarities, e.g., wall charges on the MgO layer 13 may have an opposite polarity with respect to wall charges on the red, green, and blue phosphor layers 19R, 19G, and 19B. Therefore, a voltage difference may be generated between the top substrate 1 and the red, green, and blue phosphor layers 19R, 19G, and 19B on the bottom substrate 3 due to the accumulated wall charges of opposite polarities. A secondary electron emission coefficient of the MgO layer 13 and surface charges of the red, green, and blue phosphor layers 19R, 19G, and 19B may directly affect the amount of wall charges accumulated on each of the MgO layer 13 and red, green, and blue phosphor layers 19R, 19G, and 19B, thereby controlling the voltage difference therebetween.

When the voltage difference reaches a predetermined level, a voltage having a polarity corresponding to wall charges accumulated on the top and bottom substrates 1 and 3 may be applied to respective address and scan electrodes A and X to generate address discharge therebetween. Thus, the address discharge voltage may be lowered by effectively accumulating a predetermined level, i.e., amount, of the wall charges. The amount of accumulated wall charges on the red, green, and blue phosphor layers 19R, 19G, and 19B may vary according to a composition thereof, i.e., surface charge characteristic of respective compositions of the red, green, and blue phosphor layers 19R, 19G, and 19B. In order to increase discharge stability of the PDP and to reduce a probability of generating a defective discharge, the red, green, and blue phosphor layers 19R, 19G, and 19B may include compositions exhibiting positive values of surface charge characteristics regardless of the R, G, and B colors.

In particular, the green phosphor according to an example embodiment may exhibit a positive surface charge value, thereby increasing discharge stability and reducing discharge defects thereof, i.e., the probability of generating the discharge defect is deeply related to a method of driving the PDP. In contrast, conventional green phosphor, e.g., Zn₂SiO₄:Mn, exhibiting a negative surface charge value, e.g., about −50 μC/g, may offset the positive wall charges accumulated thereon, thereby requiring a higher address voltage than the red and blue discharge cells and causing unstable discharge.

### EXAMPLES

Example 1 and Comparative Examples 1-7 of green phosphors were prepared according to compositions indicated in Table 1 below. It is noted that in Example 1, a BAM based green phosphor, i.e., a green phosphor according to an example embodiment, was formed to include a metal oxide coating of 5 wt % based on the total weight of the green phosphor. A zeta potential of each of the green phosphors in Example 1 and Comparative Examples 1-7 was measured by a zeta potential measurer. Color coordinates of each green phosphor were determined. Results are reported in Table 1.

TABLE 1

| | Green Phosphor | X | Y | Zeta potential |
|---|---|---|---|---|
| | Composition | coordinate | coordinate | (mV) |
| Comparative | Zn₂SiO₄:Mn - \textcircled{1} | 0.251 | 0.702 | −40.3 |
| Example 1 | | | | |
| Comparative | Zn₂SiO₄:Mn - \textcircled{2} | 0.247 | 0.703 | −35.7 |
| Example 2 | | | | |
| Comparative | Coated- | 0.248 | 0.700 | 20 |
| Example 3 | Zn₂SiO₄:Mn - \textcircled{1} | | | |
| Comparative | Coated- | 0.251 | 0.702 | 2.8 |
| Example 4 | Zn₂SiO₄:Mn - \textcircled{2} | | | |
| Comparative | YBO₃:Tb - \textcircled{1} | 0.329 | 0.611 | 27 |
| Example 5 | | | | |
| Comparative | YBO₃:Tb - \textcircled{2} | 0.329 | 0.610 | 24.1 |
| Example 6 | | | | |
| Comparative | BAM:Mn | 0.132 | 0.753 | −10.9 |
| Example 7 | | | | |
| Example 1 | Coated BAM:Mn | 0.132 | 0.753 | 23.1 |

As illustrated in Table 1, the green phosphor of Example 1, i.e., a coated BAM-based green phosphor according to an example embodiment, had a higher Y coordinate than green phosphors in the Comparative Examples 1-7, thereby exhibiting a higher degree of purity of green color. Since the green phosphor according to an example embodiment prevents brightness from deteriorating due to the coated metal oxide layer and has a high zeta potential, the discharge characteristic thereof may be improved.

It is noted that in Comparative Examples 1-2 the zeta potential values were negative, i.e., indicating a probability of defective discharge as discussed previously. In Comparative Examples 3-4, i.e., coated Zn₂SiO₄:Mn, even though the zeta potential values were positive, the green color coordinates were low, i.e., indicating reduced green color purity. In Comparative Examples 5-6, i.e., Zn₂SiO₄:Mn mixed with YBO₃:Tn, even though the zeta potential values were positive, the green color coordinates were substantially offset, i.e., indicating reduced green color purity. In Comparative Example 7, i.e., non-coated BAM phosphor, the zeta potential was negative, so pixels of a PDP realized by the non-coated BAM green phosphor may have reduced discharge stability and lifespan.

A green phosphor according to an example embodiment may exhibit a positive zeta potential, so a PDP including the green phosphor may have an enhanced lifespan and high discharge stability. The green phosphor according to an example embodiment exhibited improved protection of the BAM based green phosphor, e.g., in terms of color purity, while exhibiting a total positive surface charge, i.e., offsetting a negative charge characteristic of a non-coated BAM based phosphor. That is, example embodiments are based on superior and unexpected results of coating a metal oxide, e.g., a passivation layer, on a BAM-based green phosphor.

Example embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A green phosphor for a plasma display panel (PDP), comprising:
a BAM based green phosphor; and
a passivation layer on the BAM based green phosphor, the passivation layer including a metal oxide.

2. The green phosphor for a PDP as claimed in claim 1, wherein the BAM based green phosphor includes BaMgAlₓO_{y}:Mn and/or (Ba,Sr,Mg)O αAl₂O₃:Mn, x being an integer in a range of about 10≦x≦20, y being an integer in a range of about 15≦y≦30, and a being an integer in a range of about 1≦α≦23.

3. The green phosphor for a PDP as claimed in claim 1, wherein the metal oxide has a positive surface charge.

4. The green phosphor for a PDP as claimed in claim 3, wherein the metal oxide includes one or more of MgO, Al₂O₃, Y₂O₃, and ZnO.

5. The green phosphor for a PDP as claimed in claim 3, wherein an amount of the metal oxide in the green phosphor is about 0.5 wt % to about 5.5 wt % based on a total weight of the green phosphor.

6. The green phosphor for a PDP as claimed in claim 1, wherein the passivation layer is on an outer surface of the BAM based green phosphor.

7. A plasma display panel (PDP), comprising:
a first substrate and a second substrate separated from each other by a predetermined distance to face each other;
barrier ribs between the first and second substrates to define discharge cells; and
phosphor layers in the discharge cells, the phosphor layers including at last one green phosphor layer, the green phosphor layer including,
a BAM based green phosphor; and
a passivation layer on the BAM based green phosphor, the passivation layer including a metal oxide.

8. The PDP as claimed in claim 7, wherein the BAM based green phosphor includes BaMgAlₓO_{y}:Mn and/or (Ba,Sr,Mg)O αAl₂O₃:Mn, x being an integer in a range of about 10≦x≦20, y being an integer in a range of about 15≦y≦30, and a being an integer in a range of about 1≦α≦23.

9. The PDP as claimed in claim 7, wherein the metal oxide has a positive surface charge.

10. The PDP as claimed in claim 7, wherein the metal oxide includes one or more of MgO, Al₂O₃, Y₂O₃, and ZnO.

11. The PDP as claimed in claim 7, wherein an amount of the metal oxide in the green phosphor is about 0.5 wt % to about 5.5 wt % based on a total weight of the green phosphor.
